(19) United States
(12) Patent Application Publication
(10) Pub. No.: US 2016/0067530 A1
(43) Pub. Date: Mar. 10, 2016

(54) AIR GULLY MANIFOLD

(71) Applicant: Walton W. McCarthy, Forney, TX (US)

(72) Inventor: Walton W. McCarthy, Forney, TX (US)

(21) Appl. No.: 14/480,358

(22) Filed: Sep. 8, 2014

(51) Int. Cl. A62B 13/00; F24F 11/00; E04H 9/12; F24F 11/02

(52) U.S. Cl. CPC A62B 13/00; F24F 11/022; F24F 11/0001; E04H 9/12

(57) ABSTRACT

An aerodynamically smooth air manifold designed for use with an underground shelter located very close to ground zero, including a manifold body; a bottom plate under the manifold body; a manifold cover atop the manifold body; a baffle; an air pipe; a gully surrounding the top outside manifold body; a rolled angle ring surrounding the bottom outside manifold body; a plurality of first fasteners that secure a bottom flange of the air pipe and the bottom plate together; and a plurality of second fasteners that secure the rolled angle ring and the bottom plate together.

### FIELD OF THE INVENTION

The present invention relates generally to emergency underground shelters, and specifically, to air inlets and air outlets for such shelters.

### BACKGROUND

There is a misconception about underground shelters and intruder assaults. It is believed that people will try to break into the main hatch with guns or equipment. The inventor's experience from Hurricane Hugo and Hurricane Andrew, on the other hand, is that people tried to break into the shelter by assaulting the air manifolds of the shelters. The purpose of such an assault is to force the shelterists out so that the underground shelter may then be taken over by the intruders. Unlike an attack on the hatch, the air manifold attack leaves the shelter intact and usable for the intruders.

In order for an underground shelter to be inhabitable, air needs to be able to enter the shelter. The conventional method for air entering an underground shelter is a gooseneck 50 or pipe cap 52, such as those shown in FIG. 1. When the gooseneck is subjected to impact from flying debris, its failure mode is to fold over and pinch the air inlet or air outlet pipe, thus blocking the air passage into or out of the shelter. Such air inlets or manifolds should only be used for shelters that have no blast rating. Such air inlets may, for example, be used with a fallout shelter that is not designed to be located at a distance from a detonation where there is any type of blast wind. If the shelter is designed for use during and after a blast and for impact resistance from flying debris, however, such conventional air inlet methods are inadequate, and another aerodynamically designed manifold must be employed.

Therefore a more robust air manifold designed to resist flying debris and high winds, such as those that may occur at a close distance from a nuclear weapon or tornado, is needed.

### SUMMARY OF THE INVENTION

The present invention is an air manifold and air manifold system designed for use with underground shelters.

The air manifold of the present invention includes a manifold body, a bottom plate disposed beneath the manifold body, and a manifold cover disposed on top of the manifold body. The air manifold also includes a baffle. The baffle includes a baffle body and a baffle lip. The baffle body extends downward from and is attached to the bottom of the manifold cover. The baffle lip extends inward at a right angle from the baffle body. The air manifold also includes an air pipe. The air pipe includes a top lip, a bottom flange, and an air pipe body extending between the top lip and bottom flange. The top lip of the air pipe is disposed above the baffle lip and the bottom flange of the air pipe is disposed directly on top of the bottom plate, to which it is secured. The air manifold also includes a blast valve disposed around the air pipe body. The air manifold also includes a gully surrounding the top outside of the manifold body. The gully includes a manifold side where it attaches to the manifold body, an other side opposite from the manifold side, and a floor. The manifold side includes a screen. The screen is preferably a series of round, 3 inch diameter air in push in aluminum screens positioned at regular intervals around the manifold side. A top flange of the blast valve is positioned almost at a level with the top of the screen. The floor of the gully includes drain holes. The gully floor is preferably at or above ground level of the site. In some situations, where the entire manifold is above ground using a berm, this is a given. The air manifold also includes a rolled angle ring, which surrounds the bottom outside of the manifold body. The rolled angle ring is a rolled angle that continues all the way around the manifold body. The rolled angle ring includes a right angle, with an angle ring bottom that is disposed directly upon and is securely attachable to the bottom plate, and an angle ring side that is flush with the manifold body. It is understood that in referring to the rolled angle “ring,” the preferred round shape is being referred to, but that the rolled angle ring may be rectangular or other shaped in non-preferred embodiments where the manifold body is not cylindrical. Finally, the air manifold also includes first fasteners that attach the air pipe bottom flange securely to the bottom plate, and second fasteners that attach the angle ring bottom securely to the bottom plate. The first and second fasteners are preferably V2 inch cap screws or machine bolts.

The air manifold is preferably made of steel. The steel is preferably carbon steel. Stainless steel underground corrodes more than carbon steel because the corrosion resistance of stainless steel is based on an aerobic environment whereas underground is an anaerobic environment. The air manifold may also be made of fiberglass reinforced plastic (FRP). The air pipe is preferably made of fiberglass, and may be steel epoxy coated. It is preferred that the manifold body, blast valve, air pipe body, baffle, and gully are all cylindrical in shape, with a common center point. The preferred cylindrical shape puts the manifold body in hoop stress, which allows it to resist the high external pressure. In non-preferred embodiments of the present invention, these features may be rectangular or other shaped, rather than cylindrical, but the wall thickness of any of the features would need to be thicker than their cylindrical counterparts, in order to resist the high external pressure that is addressed by their cylindrical counterparts through hoop stress, as discussed above. The preferred cylindrical manifold body is 24 inches in diameter, but may have a lesser or greater diameter. The preferred manifold is also has a depth of approximately 24 inches, but may have a lesser or greater depth. As used herein, “depth” of the manifold refers to the distance between the manifold cover and the bottom plate. Although the manifold cover may be flat, it is preferred that it is convex away from the manifold body, or curved upward from the ground, and that its edges extend slightly out from where the manifold cover sits on top of the manifold body, so that liquid, such as rain, that encounters the manifold cover drains down into the gullies of the air manifold. The convex manifold cover is also advantageous in that, unlike with a flat manifold cover, most debris that falls and rests on the convex manifold cover will not have a glove fit that shuts off the air flow. It is preferred that the air manifold also include a coupling that is connected to a ceiling vent in the top of the underground shelter. This coupling is preferably a 2 inch coupling. It acts as an air outlet manifold.

The air manifold system of the present invention includes the air manifold of the present invention, as described above, and a lower air pipe. The lower air pipe connects directly to the underground shelter. The lower air pipe includes a flange that is disposed directly below and securable to the bottom plate of the air manifold. The first fasteners that secure the air pipe bottom flange of the air manifold to the bottom plate also secure the lower air pipe's flange to the bottom plate. In this manner, the bodies of the air pipe of the air manifold and the lower air pipe are aligned. The lower air pipe also includes a seismic joint. This seismic joint allows the system to move with ground movement and vibrations. The lower air pipe, like the air pipe of the air manifold, is also preferably made of fiberglass.

The air manifold of the present invention is disposed in a hole in the ground at a site where an underground shelter is located. The air manifold includes an edge where the manifold body and manifold cover meet. This edge must be at least 12 inches above the 100 year flood level or storm surge for the site and at least 4 inches above the ground level of the site. Once the air manifold is properly positioned in the hole at the site, the space around the air manifold is filled in with crushed stone at least to the level of the gully floor to facilitate drainage. The hole is filled up all the way to the manifold cover, however. Crushed stone may be used to fill all the way to the manifold cover, but the gradient between the edge and the ground level is preferably filled with soil or other materials on top of the crushed stone in order to make the air manifold less conspicuous.

The air manifold system is aerodynamically smooth and is designed to resist flying debris from winds up to 350 miles per hour, which can occur at a close distance from a nuclear weapon or a tornado. The preferred air manifold system is capable of moving 1200 cubic feet per minute of air in and out of the underground shelter.

These aspects of the present invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is a side, cut-away view of two prior art air manifolds.

FIG. 2 is a side, cut-away diagram of the air manifold system of the present invention.

FIG. 3 is a top view diagram of the air manifold system of the present invention.

FIG. 4 is a diagram showing the unlikely path that liquid would have to follow in order to get into the air pipe of the air manifold.

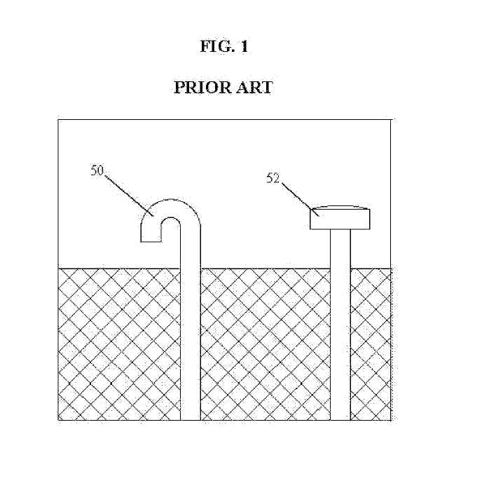

### DETAILED DESCRIPTION

Now referring to FIG. 2, a side cut-away view of the air manifold system 100 of the present invention is provided. Air manifold system 100 includes air manifold 2 and lower air pipe 32. Air manifold 2 is preferably has a diameter 75 and a depth 71, each of approximately 24 inches and is made of steel or FRP. Air manifold 2 includes manifold body 74, manifold cover 8, and bottom plate 28. Manifold body 74 extends between manifold cover 8 and bottom plate 28, and includes an outside 68, a top 70, near the manifold cover 8, and a bottom 72, near the bottom plate 28. An annular space or cavity 80 is formed within these aspects of the manifold body 74. Within this annular cavity 80, air manifold 2 also includes baffle 10, air pipe 6, and blast valve 4. Baffle 10 is attached to manifold cover 8 and extends downward therefrom into cavity 80. Baffle 10 includes baffle body 54 that extends down from manifold cover 8 and baffle lip 56 that extends inward from baffle body 54 at a right angle. Air pipe 6 includes air pipe body 58, air pipe top lip 18, and air pipe bottom flange 20. Air pipe top lip 18 is disposed above baffle lip 56. Air pipe bottom flange 20 is disposed directly on top of bottom plate 28. Air pipe bottom flange 20 is securely attachable to bottom plate 28 with first fasteners 42. First fasteners 42 are preferably ½ inch cap screws or machine bolts.

Blast valve 4 surrounds air pipe body 58. Blast valve 4 is preferably a large stainless steel poppet valve with a standard 6 or 8 inch pipe flange on each end with a standard bolt circle pattern. A blast valve is used to protect a shelter from the effects of sudden outside air pressure changes that will cause underpressure or overpressure within the shelter. A nuclear weapon, for example, creates a shock wave, which may produce sudden pressure changes of more than one atmosphere even several miles from the detonation point. After the shock wave passes, a sudden negative pressure follows. If such pressure waves enter a shelter, they will likely do substantial harm to occupants and equipment. If a blast valve is located inside the shelter, the blast valve may be subjected to reflected over or underpressure that is much higher than pressure at the ground surface. The air manifold system 100 allows the blast valve 4 to be secured inside the air manifold 2. This placement allows the air pipe 6 to remain open normally, but to automatically close when strong pressure is applied in either direction. In addition, the air manifold system 100 allows the blast valve 4 to be inspected by digging down and removing the manifold body 74. The extension of the bottom plate 28 beyond the width 75 of the air manifold 2 also provides resistance of the system 100 to hydrostatic pressure and negative pressure after a blast or from a tornado.

Air manifold 2 also includes gully 14 surrounding the outside 68 top 70 of manifold body 74. Gully 14 includes manifold side 62 where gully 14 is attached to manifold body 74, other side 64, and gully floor 66. Manifold side 62 includes a screen 16, not visible in this view. Screen 16 is preferably a series of round, 3 inch diameter air in push in aluminum screens positioned at regular intervals around manifold side 62 of gully 14. Gully floor 66 includes drain holes 22, also not visible in this view. It is preferred that manifold cover 8 be slightly convex away from the manifold body 74, or curved upward as shown, and that its edges extend slightly outward past the manifold body 74, so that liquid that comes in contact with the manifold cover 8 simply drains into the gully 14 and down through the drain holes 22.

Air manifold 2 also includes rolled angle ring 30. Rolled angle ring 30 includes an angle ring bottom 38 and an angle ring side 40. Angle ring bottom 38 is flush with and securely attachable to bottom plate 28 with second fasteners 43. Second fasteners 43, like first fasteners 42, are preferably ½ inch cap screws or machine bolts. Angle ringside 40 is flush with manifold body 74.

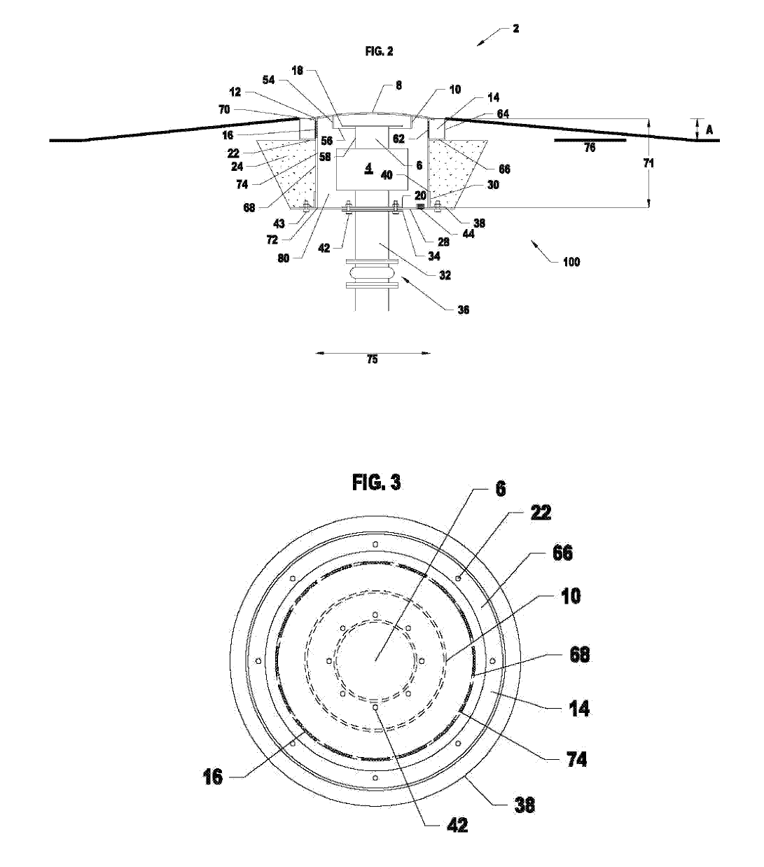

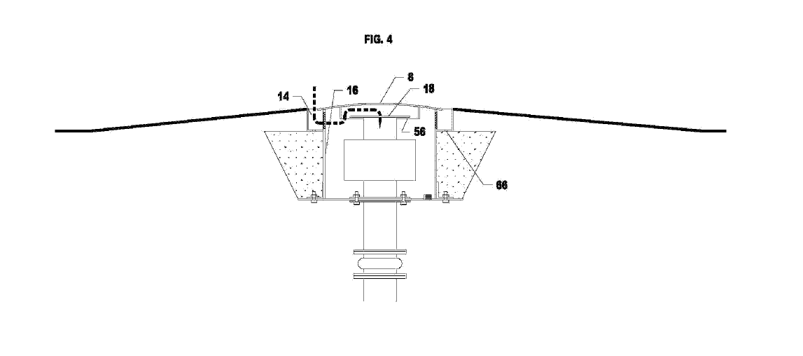

FIG. 3 is a top view diagram of air manifold 2 that illustrates the concentricity of cylindrical gully 14 with gully floor 66 and drain holes 22; rolled angle ring 30, with angle ring bottom 38 shown; manifold body 74; baffle 10; and air pipe 6 secured to bottom plate 28 (shown in FIG. 2) with first fasteners 42. It is understood that blast valve 4 is also cylindrical and concentric with these features and disposed around air pipe 6. The preferred cylindrical shape puts manifold body 74 in hoop stress, which allows it to resist the high external pressure.

Lower air pipe 32 connects to an underground shelter. Lower air pipe 32 includes lower air pipe flange 34 and seismic joint 36. Lower air pipe flange 34 is disposed directly below and securely attached to bottom plate 28 of air manifold 2. This connection aligns air pipe 6 and lower air pipe 32. Lower air pipe 32 is preferably made of fiberglass. The seismic joint 36 allows the air manifold 2 to move with ground movements and vibrations.

Air manifold 2 also includes pipe coupling 44. Coupling 44 connects to the ceiling vent in the top of the underground shelter, and functions as an air outlet device. Coupling 44 is preferably 2 inches.

Air manifold 2 is disposed in a hole in the ground at a site where an underground shelter is located. Edge 12, where manifold body 74 and manifold cover 8 meet must be at least 12 inches above the 100 year flood level or storm surge for that site. In addition, that edge 12 must be at least 4 inches A above ground level 76 at the site, so that air manifold 2 is bermed on about a 5 degree slope. Once air manifold 2 is properly position in the hole at the site, the space around the air manifold 2 is filled in with crushed stone 24 at least from the level of the gully floor 66. Crushed stone 24 is used to facilitate drainage from drain holes 22 in gully floor 66. Local soil is used for the gradient between the gully 14 and ground level 76 to make the site less conspicuous given the site surroundings.

The air manifold system 100 shown is aerodynamically smooth and is designed to resist flying debris from winds up to 350 miles per hour, which can occur at a close distance from a nuclear weapon or a tornado. The preferred air manifold system 100 is capable of moving 1200 cubic feet per minute of air in and out of the underground shelter with relatively low static pressure.

There are four basic manners in which an intruder may assault an air manifold of an underground shelter: First, a vehicle may drive over the air manifold and damage it. Second, water, fuel, or other liquid may be poured into the air manifold, and ignited if it is a flammable liquid. Third, the air manifold may be disassembled so that such liquids may be poured into the underground shelter. Finally, the air manifold may be blocked with some type of cloth or plastic. The air manifold system 100 addresses these potential assaults. First, it is strong enough to resist vehicles traveling on top of it and heavy debris coming to rest on it after being moved from high winds. The round manifold body 74 acts like a column when heavy traffic rolls over the cover 8, which is resisted by the bottom plate 28, which is resting on the soil. Second, it would be basically impossible for liquid to get into the air pipe 6. Referring to the dotted line in FIG. 4, liquid would have to take the unlikely path of going into gully 14, getting through screen 16, which is protected by the overhang of manifold cover 8, traveling laterally, then up past the baffle lip 56, then laterally again to get past the air pipe top lip 18, then up again, and finally down into the air pipe 6. Rain simply drains out of the drain holes 22 in the gully floor 66. Third, disassembly could only occur after the air manifold 2 is excavated, which would take great effort and time. Gasoline powered concrete saws, excavators, and cutting torches are real threats that would aid in such disassembly, but few people would have the skills to use these tools, even assuming they were available and operating. Finally, a plastic garbage bag could be placed over the air manifold 2. To address this threat, the underground shelter with which the air manifold 2 is used is designed with a second non-visible or disguised air manifold 2. With only one of the air manifolds 2 visible, the idea is that intruders will place the garbage bag over the visible air manifold 2, but the non-visible air manifold 2 will continue operating so that air into and out of the shelter is not affected. The inventor has encountered this situation in real life when his underground shelters were assaulted during Hurricanes Andrew and Hugo. Defending the air manifolds is the main issue with underground shelters, and no air manifold is impenetrable. In addition to the above discussion, this issue is usually addressed by having an emergency escape hatch that is not visible from the ground, which would allow shelterists to open up a hatch and surprise the intruders, allowing the shelterists to use tear gas, guns, or other weapons to disable the intruders.

Although the present invention has been described in considerable detail with reference to certain preferred versions thereof, other versions would be readily apparent to those of ordinary skill in the art. Therefore, the spirit and scope of the description should not be limited to the description of the preferred versions contained herein.

What is claimed is:

1. An air manifold designed for use with an underground shelter comprising:
a manifold body;
a bottom plate disposed beneath said manifold body;
a manifold cover disposed on top of said manifold body;
a baffle comprising a baffle body extending downward from and attached to said manifold cover and a baffle lip extending inward from said baffle body at a right angle from said baffle body;
an air pipe comprising a top lip, a bottom flange, and an air pipe body extending between said top lip and said bottom flange, wherein said top lip of said air pipe is disposed above said baffle lip and wherein said bottom flange of said air pipe is disposed directly on top of and is securable to said bottom plate;
a blast valve disposed around said air pipe body;
a gully surrounding said manifold body, disposed on an outside and top of said manifold body, wherein said gully comprises a manifold side where said gully is attached to said manifold body and said manifold side comprises a screen; an other side; and a floor comprising drain holes;
a rolled angle ring surrounding said manifold body, disposed on said outside and bottom of said manifold body, wherein said rolled angle ring comprises an angle ring bottom disposed directly upon and attachable to said bottom plate and an angle ring side that is flush with said manifold body;
a plurality of first fasteners that are able to secure said bottom flange of said air pipe and said bottom plate together; and
a plurality of second fasteners that are able to secure said angle ring bottom and said bottom plate together.

2. The air manifold as claimed in claim 1, wherein said manifold body, said baffle body, said blast valve, said air pipe body, and said gully are cylindrical in shape, each having a common center point.

3. The air manifold as claimed in claim 2, wherein said manifold body is between 23 and 25 inches in diameter.

4. The air manifold as claimed in claim 1, further comprising a depth of between 23 and 25 inches.

5. The air manifold as claimed in claim 1, wherein said air manifold is made of steel.

6. The air manifold as claimed in claim 1, wherein said air manifold is made of FRP.

7. The air manifold as claimed in claim 1, wherein said first and second fasteners are cap screws.

8. The air manifold as claimed in claim 1, wherein said air pipe is made of fiber glass.

9. The air manifold as claimed in claim 1, wherein said manifold cover is convex away from said manifold body and extends slightly beyond said manifold body such that liquid placed upon said manifold cover drains off of said manifold cover and into said gully.

10. The air manifold as claimed in claim 1, further comprising a coupling extending through said bottom plate, wherein said coupling is connected to a ceiling vent of the underground shelter for an air outlet manifold.

11. An air manifold system designed for use with an underground shelter at a site comprising:
an air manifold comprising:
a manifold body;
a bottom plate disposed beneath said manifold body;
a manifold cover disposed on top of said manifold body;
an edge where said manifold body and said manifold cover meet, wherein said edge is disposed at least 12 inches above a 100 year flood level at the site;
a baffle comprising a baffle body extending downward from and attached to said manifold cover and a baffle lip extending inward from said baffle body at a right angle from said baffle body;
a manifold air pipe comprising a manifold air pipe top lip, a manifold air pipe bottom flange, and a manifold air pipe body extending between said manifold air pipe top lip and said manifold air pipe bottom flange, wherein said manifold air pipe top lip is disposed above said baffle lip and wherein said manifold air pipe bottom flange is disposed directly on top of and is securable to said bottom plate;
a blast valve disposed around said manifold air pipe body;
a gully surrounding said manifold body, disposed on an outside and top of said manifold body, wherein said gully comprises a manifold side where said gully is attached to said manifold body and said manifold side comprises a screen;
an other side; and a floor comprising drain holes;
a rolled angle ring surrounding said manifold body, disposed on said outside and bottom of said manifold body, wherein said rolled angle ring comprises an angle ring bottom disposed directly upon and attachable to said bottom plate and an angle ring side that is flush with said manifold body;
a plurality of first fasteners that are able to secure said manifold air pipe bottom flange and said bottom plate together; and
a plurality of second fasteners that are able to secure said angle ring bottom and said bottom plate together; and
a lower air pipe connected directly to the underground shelter, comprising a seismic joint and a lower air pipe flange disposed directly below and securable to said bottom plate of said manifold, wherein said first fasteners are able to secure said manifold air pipe bottom flange, said bottom plate of said manifold, and said lower air pipe flange together such that said manifold air pipe and said lower air pipe form a continuous pipe;
wherein said air manifold is disposed in a hole at the site, wherein:
a space surrounding said air manifold within the hole is filled with crushed stone at least up to said floor of said gully of said air manifold;
the space between said floor of said gully of said air manifold and said manifold cover of said air manifold is also filled; and
said top of said manifold body of said air manifold is at least 4 inches above a ground level of the site.

12. The air manifold system as claimed in claim 11, wherein said manifold body, said baffle body, said blast valve, said manifold air pipe body, and said gully of said air manifold and said lower air pipe are cylindrical in shape, each disposed so as to have a common center point.

13. The air manifold system as claimed in claim 12, wherein said manifold body of said air manifold is between 23 and 25 inches in diameter.

14. The air manifold system as claimed in claim 11, wherein said air manifold further comprises a depth of between 23 and 25 inches.

15. The air manifold system as claimed in claim 11, wherein said air manifold is made of steel.

16. The air manifold system as claimed in claim 11, wherein said air manifold is made of FRP.

17. The air manifold system as claimed in claim 11, wherein said first and second fasteners of said air manifold are cap screws.

18. The air manifold system as claimed in claim 11, wherein said air pipe of said air manifold and said lower air pipe are made of fiber glass.

19. The air manifold system as claimed in claim 11, wherein said manifold cover of said air manifold is convex away from said manifold body of said air manifold and extends slightly beyond said manifold body so that liquid placed upon said manifold cover drains off of said manifold cover and into said gully of said air manifold.

20. The air manifold system as claimed in claim 11, wherein said air manifold further comprises a coupling extending through said bottom plate of said air manifold, wherein said coupling is connected to a ceiling vent of the underground shelter for an air outlet manifold.
